(19) United States
(12) Patent Application Publication
(10) Pub. No.: US 2026/0163669 A1
(43) Pub. Date: Jun. 11, 2026

(54) METHOD AND APPARATUS FOR TRANSMITTING/RECEIVING WIRELESS SIGNAL IN WIRELESS COMMUNICATION SYSTEM

(71) Applicant: LG ELECTRONICS INC., Seoul (KR)

(72) Inventors: Kijun JEON, Seoul (KR); Bonghoe KIM, Seoul (KR); Sangrim LEE, Seoul (KR); Ikjoo JUNG, Seoul (KR); Hojae LEE, Seoul (KR); Yeongjun KIM, Seoul (KR); Taehyun LEE, Seoul (KR)

(73) Assignee: LG ELECTRONICS INC., Seoul (KR)

(21) Appl. No.: 18/706,724

(22) PCT Filed: Nov. 18, 2021
(86) PCT No.: PCT/KR2021/016949

§ 371 Date: May 1, 2024

(51) Int. Cl. H04L 1/00; G06N 3/098; H04L 1/1607; H04L 27/26; H04L 41/16

(52) U.S. Cl. CPC H04L 1/0008; G06N 3/098; H04L 1/1621; H04L 27/26136; H04L 41/16

(57) ABSTRACT

The present invention relates to a wireless communication system, and particularly, to a method by which a terminal transmits a signal, and an apparatus therefor, the method comprising the steps of: generating a second data bit sequence by adding (q−u) zero bits to each of u bits in a first data bit sequence; encoding the second data bit sequence so as to generate a codeword including a system part and a parity part; applying different modulation and power scaling combinations to q-bit units for the system part and the parity part in the codeword so as to provide a modulation symbol sequence corresponding to the codeword; and transmitting the modulation symbol sequence, wherein q is the square of 2, and u is an integer greater than or equal to 1.

### TECHNICAL FIELD

The disclosure relates to a wireless communication system, and more particularly, to a method and device for transmitting and receiving a wireless signal.

### BACKGROUND ART

Wireless communication systems have been widely deployed to provide various types of communication services such as voice and data, and attempts to incorporate artificial intelligence (AI) into communication systems are rapidly increasing. AI integration methods may be largely categorized into communications for AI (C4AI), which develops communication technology to support AI, and AI for communications (AI4C), which utilizes AI to improve communication performance. In the AI4C area, there are attempts to increase design efficiency by replacing a channel encoder/decoder with an end-to-end autoencoder. In the C4AI area, there is a method of updating a common prediction model, while protecting personal information by sharing only the weights or gradients of an AI model with a server without sharing raw data, using a distributed learning technique, federated learning. Additionally, there is a method of distributing the loads of a device, a network edge, and a cloud server by using split inference.

### DISCLOSURE

### Technical Problem

An objective of the disclosure is to provide a method of effectively performing a procedure of transmitting and receiving a wireless signal and a device therefor.

It will be appreciated by persons skilled in the art that the objects that could be achieved with the disclosure are not limited to what has been particularly described hereinabove and the above and other objects that the disclosure could achieve will be more clearly understood from the following detailed description.

### Technical Solution

According to a first aspect of the disclosure, a method of transmitting a signal by a user equipment (UE) in a wireless communication system is provided, including generating a second data bit sequence by adding q−u zero bits to every u bits in a first data bit sequence, generating a codeword including a system part and a parity part by encoding the second data bit sequence, providing a modulation symbol sequence corresponding to the codeword by applying a different modulation and power scaling combination to every q-bit unit of the system part and the parity part in the codeword, and transmitting the modulation symbol sequence. q is a power of 2, and u is an integer equal to or greater than 1.

According to a second aspect of the disclosure, a UE used in a wireless communication system is provided, including at least one radio frequency (RF) unit, at least one processor, and at least one computer memory operably connected to the at least one processor, and when executed, causing the at least one processor to perform operations. The operations include generating a codeword including a system part and a parity part by encoding the second data bit sequence, providing a modulation symbol sequence corresponding to the codeword by applying a different modulation and power scaling combination to every q-bit unit of the system part and the parity part in the codeword, and transmitting the modulation symbol sequence. q is a power of 2, and u is an integer equal to or greater than 1.

According to a third aspect of the disclosure, an apparatus for a UE is provided, including at least one processor, and at least one computer memory operably connected to the at least one processor, and when executed, causing the at least one processor to perform operations. The operations include generating a codeword including a system part and a parity part by encoding the second data bit sequence, providing a modulation symbol sequence corresponding to the codeword by applying a different modulation and power scaling combination to every q-bit unit of the system part and the parity part in the codeword, and transmitting the modulation symbol sequence. q is a power of 2, and u is an integer equal to or greater than 1.

According to a fourth aspect of the disclosure, a computer-readable storage medium is provided, including at least one computer program which when executed, causes at least one processor to perform operations. The operations include generating a codeword including a system part and a parity part by encoding the second data bit sequence, providing a modulation symbol sequence corresponding to the codeword by applying a different modulation and power scaling combination to every q-bit unit of the system part and the parity part in the codeword, and transmitting the modulation symbol sequence. q is a power of 2, and u is an integer equal to or greater than 1.

Preferably, the second data bit sequence may include u data bits and q−u zero bits in each of q-bit units, and positions of the u data bits in each of the q-bit units may be changed based on an order of the q-bit units.

Preferably, the second data bit sequence may include u data bits and q−u zero bits in each of q-bit units, and positions of the u data bits in each of the q-bit units may be changed based on UE identification information.

Preferably, the first data bit sequence may include information about a training result according to federated learning, u may be q/U, and U may represent a number of UEs participating in the federated learning.

### Advantageous Effects

According to the disclosure, a wireless signal may be transmitted and received efficiently in a wireless communication system.

It will be appreciated by persons skilled in the art that the effects that may be achieved with the disclosure are not limited to what has been particularly described hereinabove and other advantages of the disclosure will be more clearly understood from the following detailed description taken in conjunction with the accompanying drawings.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 illustrates physical channels used in a 3rd generation partnership project (3GPP) system as an exemplary wireless communication systems and a general signal transmission method using the same.

FIG. 2 illustrates a radio frame structure.

FIG. 3 illustrates a resource grid of a slot.

FIG. 4 illustrates mapping of physical channels in a slot.

FIG. 5 illustrates a PDSCH transmission procedure.

FIG. 6 illustrates an exemplary PUSCH transmission procedure.

FIGS. 7 to 9 illustrate exemplary federated learning.

FIGS. 10 to 13 illustrate exemplary modulation of system bits according to an embodiment of the disclosure.

FIGS. 14 to 18 illustrate exemplary modulation of parity bits according to an embodiment of the disclosure.

FIGS. 19 and 20 illustrate exemplary simulation results.

FIG. 21 illustrates an exemplary signal transmission process according to an embodiment of the disclosure.

FIGS. 22 to 25 illustrate an example of a communication system 1 and wireless devices which are applied to the disclosure.

### MODE FOR INVENTION

Embodiments of the disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive machine type communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and ultra-reliable and low latency communication (URLLC) is being discussed. In the disclosure, for simplicity, this technology will be referred to as NR (New Radio or New RAT).

For the sake of clarity, 3GPP NR is mainly described, but the technical idea of the disclosure is not limited thereto.

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

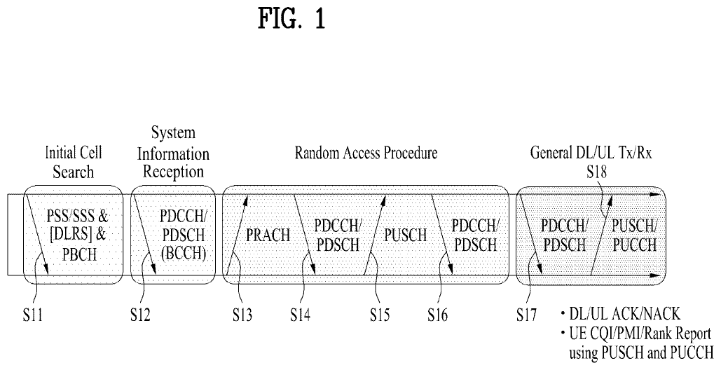

FIG. 1 illustrates physical channels used in a 3GPP NR system and a general signal transmission method using the same.

When powered on or when a UE initially enters a cell, the UE performs initial cell search involving synchronization with a BS in step S101. For initial cell search, the UE receives synchronization signal block (SSB). The SSB includes a primary synchronization signal (PSS), a secondary synchronization signal (SSS), and a physical broadcast channel (PBCH). The UE synchronizes with the BS and acquires information such as a cell Identifier (ID) based on the PSS/SSS. Then the UE may receive broadcast information from the cell on the PBCH. In the meantime, the UE may check a downlink channel status by receiving a downlink reference signal (DL RS) during initial cell search.

After initial cell search, the UE may acquire more specific system information by receiving a physical downlink control channel (PDCCH) and receiving a physical downlink shared channel (PDSCH) based on information of the PDCCH in step S102.

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

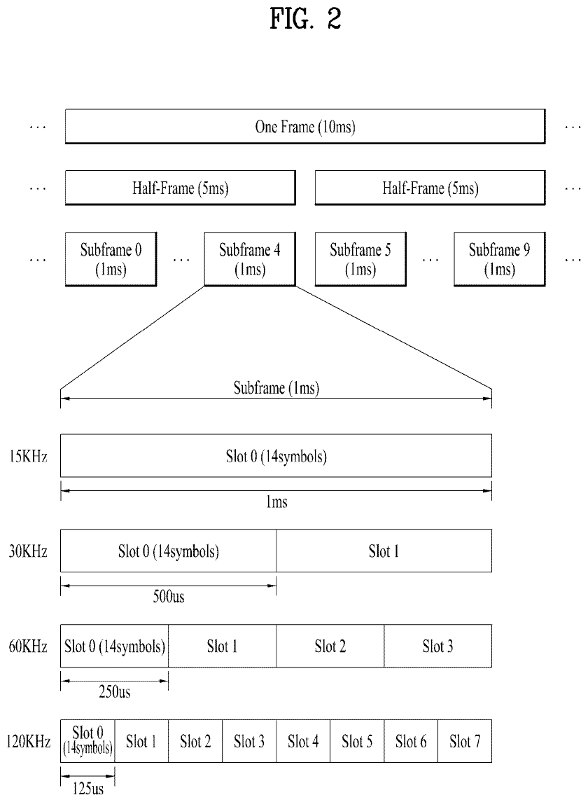

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 orthogonal frequency division multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

* N^{slot}_{symb}: Number of symbols in a slot
* N^{frame, u}ₛₗₒₜ: Number of slots in a frame
* N^{subframe, u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The frame structure is merely an example. The number of subframes, the number of slots, and the number of symbols in a frame may vary.

In the NR system, different OFDM numerologies (e.g., SCSs) may be configured for a plurality of cells aggregated for one UE. Accordingly, the (absolute time) duration of a time resource including the same number of symbols (e.g., a subframe (SF), slot, or TTI) (collectively referred to as a time unit (TU) for convenience) may be configured to be different for the aggregated cells. A symbol may be an OFDM symbol (or CP-OFDM symbol) or an SC_FDMA symbol (or a discrete Fourier transform-spread-OFDM (DFT-s-OFDM) symbol).

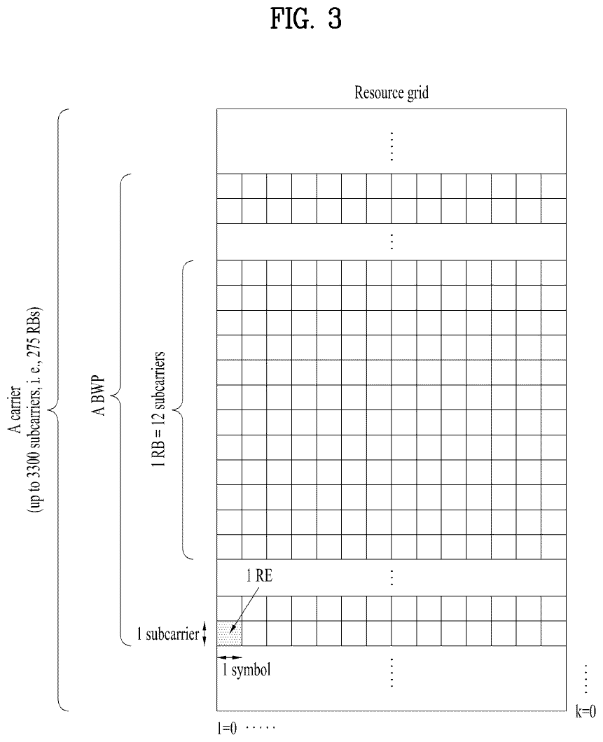

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

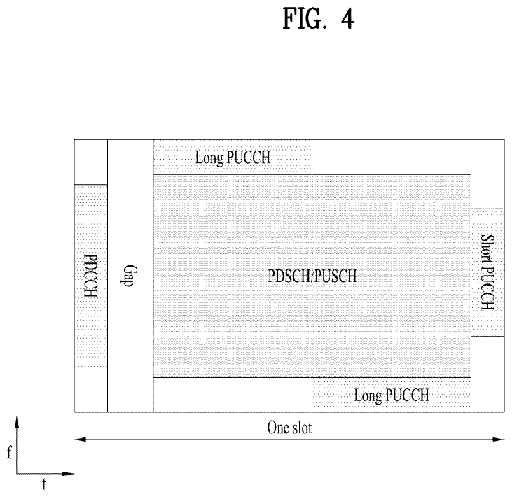

FIG. 4 illustrates exemplary mapping of physical channels in a slot. In the NR system, a frame is characterized by a self-contained structure in which all of a DL control channel, DL or UL data, and a UL control channel may be included in one slot. For example, the first N symbols of a slot may be used for a DL control channel (e.g., PDCCH) (hereinafter, referred to as a DL control region), and the last M symbols of the slot may be used for a UL control channel (e.g., PUCCH) (hereinafter, referred to as a UL control region). Each of N and M is an integer equal to or larger than 0. A resource area (referred to as a data region) between the DL control region and the UL control region may be used for transmission of DL data (e.g., PDSCH) or UL data (e.g., PUSCH). A guard period (GP) provides a time gap for switching between a transmission mode and a reception mode at the BS and the UE. Some symbol at the time of switching from DL to UL may be configured as a GP.

The PDCCH carries downlink control information (DCI). For example, the PCCCH (i.e., DCI) carries a transmission format and resource allocation of a downlink shared channel (DL-SCH), resource allocation information about an uplink shared channel (UL-SCH), paging information about a paging channel (PCH), system information present on the DL-SCH, resource allocation information about a higher layer control message such as a random access response transmitted on a PDSCH, a transmit power control command, and activation/release of configured scheduling (CS). The DCI includes a cyclic redundancy check (CRC). The CRC is masked/scrambled with different identifiers (e.g., radio network temporary identifier (RNTI)) according to the owner or usage of the PDCCH. For example, if the PDCCH is for a specific UE, the CRC will be masked with a UE identifier (e.g., cell-RNTI (C-RNTI)). If the PDCCH is for paging, the CRC will be masked with a paging-RNTI (P-RNTI). If the PDCCH is for system information (e.g., a system information block (SIB)), the CRC will be masked with a system information RNTI (SI-RNTI). If the PDCCH is for a random access response, the CRC will be masked with a random access-RNTI (RA-RNTI).

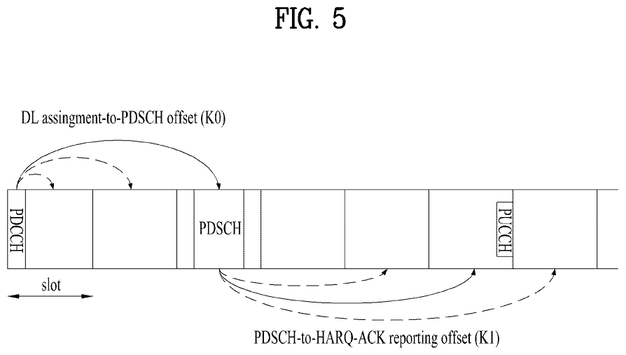

FIG. 5 illustrates a PDSCH transmission procedure. Referring to FIG. 5, the UE may detect a PDCCH in slot #n. Here, the PDCCH includes downlink scheduling information (e.g., DCI format 1_0 or 1_1). The PDCCH indicates a DL assignment-to-PDSCH offset (K0) and a PDSCH-HARQ-ACK reporting offset (K1). For example, DCI format 1_0 or 1_1 may include the following information.
Frequency domain resource assignment: Indicates an RB set assigned to the PDSCH.
Time domain resource assignment: Indicates K0 and the starting position (e.g. OFDM symbol index) and duration (e.g. the number of OFDM symbols) of the PDSCH in a slot.
PDSCH-to-HARQ_feedback timing indicator: Indicates K1.
HARQ process number (4 bits): Indicates an HARQ process identify (ID) for data (e.g., PDSCH or TB).
PUCCH resource indicator (PRI): Indicates PUCCH resources to be used for UCI transmission among a plurality of resources in a PUCCH resource set.

After receiving the PDSCH in slot #(n+K0) according to the scheduling information of slot #n, the UE may transmit UCI on the PUCCH in slot #(n+K1). Here, the UCI includes a HARQ-ACK response to the PDSCH. In the case where the PDSCH is configured to transmit a maximum of one TB, the HARQ-ACK response may be configured in one bit. In the case where the PDSCH is configured to transmit a maximum of two TBs, the HARQ-ACK response may be configured in two bits if spatial bundling is not configured and may be configured in one bit if spatial bundling is configured. When slot #(n+K1) is designated as a HARQ-ACK transmission time for a plurality of PDSCHs, the UCI transmitted in slot #(n+K1) includes HARQ-ACK responses to the plurality of PDSCHs.

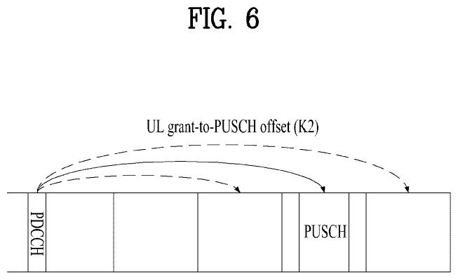

FIG. 6 illustrates an exemplary PUSCH transmission procedure. Referring to FIG. 6, a UE may detect a PDCCH in slot #n. The PDCCH may include UL scheduling information (e.g., DCI format 0_0, DCI format 0_1). DCI format 0_0 and DCI format 0_1 may include the following information.
Frequency domain resource assignment: this indicates an RB set allocated to a PUSCH.
Time domain resource assignment: this specifies a slot offset K2 indicating the starting position (e.g., symbol index) and length (e.g., the number of OFDM symbols) of the PUSCH in a slot. The starting symbol and length of the PUSCH may be indicated by a SLIV, or separately.

The UE may then transmit the PUSCH in slot #(n+K2) according to the scheduling information in slot #n. The PUSCH includes a UL-SCH TB. When the PUCCH transmission time overlaps with the PUSCH transmission time, UCI may be transmitted on the PUSCH (PUSCH piggyback).

### Embodiment

The 3GPP has worked on standardization of a 5G system called new RAT (hereafter, NR), and discussion is underway on a 6G system as a successor to the 5G system.

The 6G system is aimed at (i) very high data rates per device, (ii) a very large number of connected devices, (iii) global connectivity, (iv) very low latency, (v) lower energy consumption for battery-free IoT devices, (vi) ultra-reliable connectivity, and (vii) connected intelligence with machine learning capabilities. The vision of the 6G system may be four aspects such as intelligent connectivity, deep connectivity, holographic connectivity, and ubiquitous connectivity, and the 6G system may fulfill the requirements as listed in Table 3.

TABLE 3

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

One of new techniques that will be introduced in the 6G system is artificial intelligence (AI). The 4G system does not involve AI, and the 5G system will have partial or very limited AI support. However, in the 6G system, AI may be fully supported for automation. Advances in machine learning will create a more intelligent network for real-time communications in 6G. The introduction of AI in communications may streamline and improve real-time data transmission. AI may use numerous analytics to determine how complex target tasks are to be performed. Time-consuming tasks such as handover, network selection, and resource scheduling may be performed instantly by using AI. AI may also play an important role in M2M, machine-to-human, and human-to-machine communications.

Although there have been attempts to integrate AI with wireless communication systems in recent years, these attempts have focused on the application layer and the network layer, especially on combining deep learning with the field of wireless resource management and allocation. However, the research is increasingly evolving to the MAC layer and the physical layer. Particularly, attempts are made to combine deep learning with wireless transmission at the physical layer. AI-based physical layer transmission means that the underlying signal processing and communication mechanisms are based on AI drivers rather than traditional communication frameworks. For example, it may include deep learning-based channel coding and decoding, deep learning-based signal estimation and detection, a deep learning-based MIMO mechanism, AI-based resource scheduling and allocation, and so on.

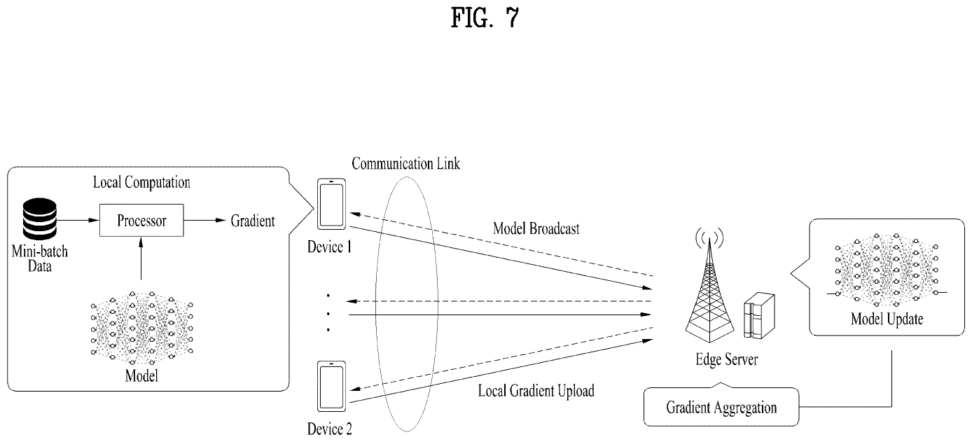

In recent years, there has been an increasing demand for a federated learning use case in which datasets collected by edge devices (e.g., smartphones or sensors) are used to train an AI model of a network edge. FIG. 7 illustrates a federated learning system. In one of distributed machine learning techniques, federated learning, each of a plurality of devices as learning entities shares local model parameters with a server, and the server updates global parameters by aggregating the local model parameters from the plurality of devices. The local model parameters may include parameters such as weights or gradients of a local model, and be expressed in a variety of manners, such as local parameters, regional parameters, and so on, as long as they may be interpreted as the same/similar. When the federated learning technique is applied to 5G communications or 6G communications, the devices may be UEs and the server may be a BS. For ease of description, the terms UE/device/transmitting end and server/BS/receiving end may be used interchangeably.

In the above process, since each device does not share raw data with the server, communication overhead may be reduced in the data transmission process, and the privacy of the device (user) may be protected.

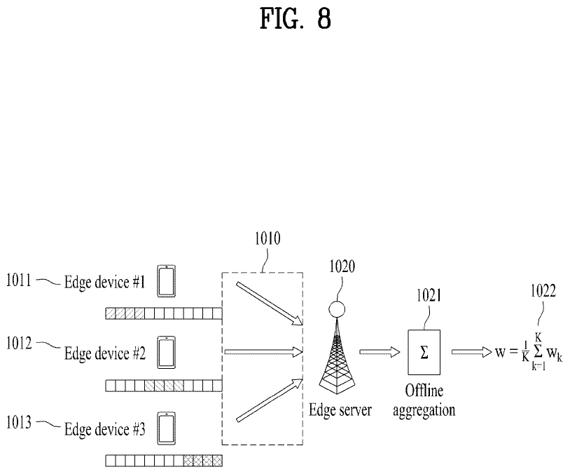

FIG. 8 illustrates an exemplary federated learning process based on orthogonal division access.

Referring to FIG. 8, devices 1011, 1012, and 1013 transmit their local parameters to a server 1020 using resources allocated to them (1010). Before transmitting the local parameters, the devices 1011, 1012, and 1013 may receive configuration information about training parameters for federated learning from the server 1020. The configuration information about the training parameters for federated learning may include parameters such as weights or gradients of local models, and training parameters included in the local parameters transmitted by the devices 1011, 1012, and 1013 may be determined based on the configuration information. After receiving the configuration information, the devices 1011, 1012, and 1013 may receive control information for allocating resources for the transmission of the local parameters. The devices 1011, 1012, and 1013 may transmit the local parameters in the allocated resources, respectively based on the control information. The server 1020 then performs offline aggregation on the local parameters received from the devices 1011, 1012, and 1013 (1021 and 1022). In general, the server 1020 derives global parameters by averaging all of the local parameters received from the devices 1011, 1012, and 1013 participating in the federated learning and transmits the derived global parameters to the devices 1011, 1012, and 1013, respectively.

However, very large overhead occurs in terms of radio resource use (i.e., as many radio resources as the number of devices participating in the learning are required linearly) during federated learning based on orthogonal division access. Moreover, in the federated learning process based on orthogonal division, as more devices participate in the learning, update of global parameters is delayed (a time required for the update is increased).

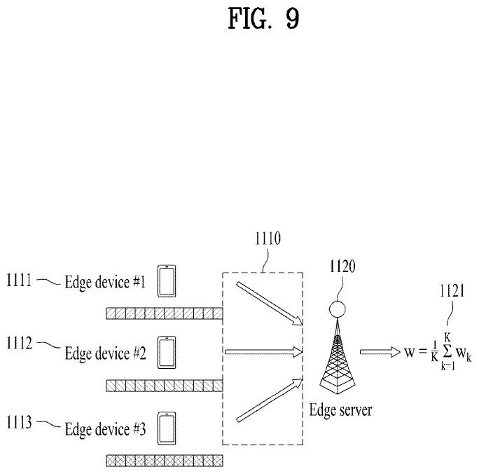

FIG. 9 illustrates an exemplary federated learning process based on over-the-air (OTA) computation. OTA computation may be referred to as Aircomp. In an AirComp-based federated learning technique, all devices participating in federated learning use the same resources to transmit local parameters. AirComp-based federated learning may solve the problem described with reference to FIG. 9 that as the number of devices participating in learning increases, a time required to update global parameters increases.

Referring to FIG. 9, devices 1111, 1112, and 1113 transmit their local parameters to a server 1120 using the same allocated resources (1110). Before transmitting the local parameters, the devices 1111, 1112, and 1113 may also perform the operations (reception of configuration information and reception of control information) performed prior to transmission of local parameters, described with reference to FIG. 8, in the same manner in FIG. 9.

The local parameters transmitted by the devices 1111, 1112 and 1113 are transmitted in an analog or digital manner. The analog manner means that pulse amplitude modulation (PAM) is simply applied to a gradient value, whereas the digital manner means that a general digital modulation scheme, quadrature amplitude modulation (QAM) or phase shift keying (PSK) is applied to a gradient value. The server 1120 may obtain the sum of the local parameters transmitted in the analog or digital manner, which are received superposed on the air (1121). The server 1120 then derives global parameters by averaging all the local parameters and transmits the derived global parameters to the devices 1111, 1112, and 1113, respectively.

In AirComp-based federated learning, the number of devices participating in the learning does not significantly affect the latency because the devices participating in the federated learning transmit their local parameters in the same resources. That is, even if the number of devices participating in the federated learning increases, the time taken to update global parameters does not change significantly, compared to a case with fewer devices. Therefore, AirComp-based federated learning may be efficient in terms of radio resource management.

In AirComp-based federated learning, however, UEs participating in the federated learning use non-orthogonal multiple access, and the resulting difficulty in applying a conventional channel coding scheme causes excessive transmission power consumption of the devices to ensure reception reliability. The UEs participating in the federated learning consume power in performing many computing operations during the learning, and additional excessive transmission power consumption to ensure reception reliability may be a heavy burden on the UEs. To address these problems, the disclosure proposes a method of performing federated learning by a plurality of UEs. More specifically, a transmission and reception method (federated learning method) for handling an aggregated codeword is proposed in the disclosure. An aggregated codeword may refer to a codeword in which codewords for local parameters transmitted by a plurality of UEs participating in federated learning are superimposed.

### Finite Field Definition

Before describing the federated learning method proposed in the disclosure, the definition of a finite field will be described.

A set F of arbitrary finite elements satisfying the following four properties is defined as a finite field.
1) Addition and multiplication are defined on the set F.
2) The commutative, associative, and distributive laws are established for addition/multiplication.
3) There exists an identity 0 for addition, and there exists an inverse identity for addition for every element f of the set F.
4) There exists an identity 1 for multiplication, and there exists an inverse identity for multiplication for every element f of the set F.

When the value of Q denoting the order of a finite field is 2^{q}, then the finite field is not defined based on a integer modulo-Q operation. A GF(2^{q}) finite field may be defined as an extension of a primitive polynomial over GF(2) with degree-q. The primitive polynomial over GF(2) with degree-q may be defined as follows.
An irreducible polynomial of degree m (a polynomial that is not expressed as a product of polynomials of a lower degree) satisfies the condition “divisible by z^{Q-1}+1 where the smallest Q is 29”.

For example, for Q=2⁴, a field GF(16) may be constructed by extending a primitive polynomial over GF(2) with degree-4. A field GF(Q) composed of primitive polynomials is denoted by [symbol] . Table 4 illustrates [symbol] using a primitive polynomial p(z)=1+z+z⁴(over GF(2)).

TABLE 4

| Symbol | Polynomial | binary vector |
|---|---|---|
| 0 | 0 | 0000 |
| α⁰ | 1 | 0001 |
| α¹ | Z | 0010 |
| α² | z² | 0100 |
| α³ | z³ | 1000 |
| α⁴ | z + 1 | 0011 |
| α⁵ | z² + z | 0110 |
| α⁶ | z³ + z² | 1100 |
| α⁷ | z³ + z + 1 | 1011 |
| α⁸ | z² + 1 | 0101 |
| α⁹ | z³ + z | 1010 |
| α¹⁰ | z² + z + 1 | 0111 |
| α¹¹ | z³ + z² + z | 1110 |
| α¹² | z³ + z² + z + 1 | 1111 |
| α¹³ | z³ + z² + 1 | 1101 |
| α¹⁴ | z³ + 1 | 1001 |

Before describing the proposals of the disclosure, rules for expressions such as equations used in the disclosure will be defined. Letters expressed as x, x, X and [symbol] represent a scalar, a vector, a matrix, and a set, respectively in this order. x[i] represents an i^{th} entry of a vector x, given as

$${[ x [ i ] ]}_{i = m}^{n} = [ x [ m ] , x [ m + 1 ] , … , x [ n ] ] .$$

( )_{q} means a modulo-q operation. [symbol] and [symbol] refer to a set of all natural numbers and a set of natural numbers smaller than Q. |x| represents the absolute value of x, and |x| represents the cardinality of the set x. β(a)=1 if a ≥0 or 0 otherwise, and 0ₙ means an all-zero vector with length n.

Hereinafter, an information field restriction-based scalable Q-ary linear code transmission/reception technique proposed in the disclosure will be described. The proposed information field restriction-based scalable Q-ary linear code transmission/reception technique is based on the assumption that power adjustment has been performed on devices (UEs) participating in federated learning to maximize the efficiency of the federated learning. During the federated learning, a signal received at a server (BS) is in the form of a weight-sum (channel+transmission power) of signals transmitted by the devices participating in the federated learning, because the effect of increasing a batch size by as much as the number of devices participating in the federated learning is achievable only when each signal has an equal weight.

The power adjustment for maximizing the efficiency of the federated learning may be performed based on the following three methods.
1) The server (BS) groups the UEs participating in the federated learning based on CSI received from the UEs, and performs fine tuning on the transmission power of the UEs belonging to the same groups. Based on the fine tuning, the server may have uniform (same) received power sensitivities for signals received from the UEs of the same groups. A representative channel value is predefined for each UE group, and the fine tuning of the power is performed using a function of a channel value between each UE and the server (receiving end).
2) When the efficiency of wireless resource management is prioritized, the server (BS/receiving end) adjusts the transmission power of all UEs based on the received signal sensitivity of a signal transmitted at maximum power by a UE related to the worst of channels between the UEs participating in the federated learning and the server. That is, the transmission power of all UEs is adjusted such that the received signal sensitivities of signals at the server, transmitted by UEs other than the UE related to the worst channel are the same as the received signal sensitivity of the signal at the server, transmitted at maximum power by the UE related to the worst channel. For this power adjustment, the server (BS/receiving end) first informs the UEs participating in the federated learning of information about the worst channel before the UEs transmit information (local parameters for the federated learning).
3) When power efficiency is prioritized for each UE participating in the federated learning, each UE participating in the federated learning transmits a signal based on maximum power, and the server (BS/receiving end) adjusts the transmission power of all UEs based on the received signal sensitivity of a signal transmitted at maximum power by a UE related to the best of channels between the UEs participating in the federated learning and the server. That is, the transmission power of all UEs is adjusted such that the received signal sensitivities of signals at the server, transmitted by UEs other than the UE related to the best channel are the same as the received signal sensitivity of the signal at the server, transmitted at maximum power by the UE related to the best channel. For this power adjustment, the server (BS/receiving end) first reports information about the best channel to the UEs participating in the federated learning before the UEs transmit information (local parameters for the federated learning), and each of the UEs adjusts a retransmission number and a retransmission power level based on the report.

Hereinafter, it is assumed that power adjustment is performed on devices (UEs) participating in federated learning based on at least one of the above-described three methods, and that the server (receiving end) receives a signal from each UE with the same reception sensitivity.

### Information and Encoding

Let [symbol] ={1, . . . , U} be an entire set of devices participating in federated learning, and let [symbol] be a finite field over which non-binary coding is performed. It is assumed that q is at least equal to or greater than U. Let a binary information sequence of length qK (i.e., qK bits) of device-u be

$${I}_{u}^{b} = {[ {i}_{u}^{b} [ k ] ]}_{k = 1}^{qK} .$$

Also, let the degree of information freedom be μ∈{1, . . . , q/U}. The degree of information freedom means the degree/number of bits in which device-u is capable of loading information in a subsequence of length q, and the remaining q-μ bits are zero-padded. For example, when U=4 and q=4, device-u may generate an information sequence of 4*K bits, with one bit of each length-4 subsequence carrying information and the remaining three bits thereof zero-padded.

$${I}_{u}^{b}$$

may be expressed as follows.

$${I}_{u}^{b} = {[ {I}_{u , k}^{b} ]}_{k = 1}^{K} where {I}_{u , k}^{b} ∈ σ ( {𝔹}_{q , u} , {( u + k + 1 )}_{U} ) and {𝔹}_{q , u} = {\{ [ d 2 b ( l , u ) , {0}_{q - μ} ] \}}_{l = 0}^{{2}^{μ} - 1} \qquad [ Equation 1 ]$$

Herein, d2b(l, μ) is a function that converts a decimal number l into a length-μ binary vector, and σ( [symbol] , a) means a set obtained by cyclically shifting the elements of a set [symbol] (to the right) by a. ( )_{U} means a modulo-U operation.

$${I}_{u}^{b}$$

has qK bits and is composed of K length-q subsequences (q bits).

$${I}_{u , k}^{b}$$

represents a k^{th} length-q subsequence. [symbol] represents a length-q subsequence which has not been cyclically shifted. k represents the index of a length-q subsequence. u represents the index of a device participating in federated learning. b represents a binary sequence. U represents the number of devices participating in the federated learning.

The reason for changing an information sequence set in units of a length-qsubsequence for each device (i.e., cyclically shifting an information position within a length-q subsequence) is to make the average power of signals modulated at the rear end of an encoder equal for each device. Cyclic shift may be performed based on the index of a device and/or the index of a length-q subsequence.

Further, let a Q-ary symbol sequence representation (Q is 2^{q}) of a binary sequence

$${I}_{u}^{b}$$

be denoted by Iᵤ. Let a parity check matrix defined in a finite field [symbol] be denoted by

$$H ∈ {ℤ}_{Q}^{M \times N} ( M = N - K ) .$$

Let a binary representation of H be H^{b}∈{0,1}^{qM×qN} and let a generation matrix be G^{b}=[Iₖ, P](∈{0,1}^{qK×qN}). An encoded codeword is

$${c}_{u}^{b} = {( {G}^{b} )}^{T} {I}_{u}^{b} ,$$

and the systematic part of the codeword is

$${[ {c}_{u}^{b} [ k ] ]}_{k = 1}^{qK} = {I}_{u}^{b} .$$

The Q-ary symbol sequence of the codeword

$${c}_{u}^{b}$$

is defined as cᵤ.

### Modulation

The system part and parity part of the codeword generate modulation signals based on different modulation rules. This is a characteristic caused by information restriction.

### [System Part]

A modulation order is determined by the number U of users participating in federated learning and the degree of information freedom u. When the system part of the codeword is divided into length-q subsequences, only μ bits in a length-q subsequence are used to transmit information, and the remaining (e.g., trailing) q-μ bits are always zero-padded and unused. No. Accordingly, the system part

$${c}_{u}^{sys , b}$$

of the codeword may be defined as follows.

$${c}_{u}^{sys , b} = \{ \begin{matrix}{[ {c}_{u}^{b} [ k ] ]}_{k = 1}^{qK} , & if q = μ U , \\ {[ {c}_{u}^{b} [ q ( k - 1 ) + l ] ]}_{l = 1 , k = 1}^{μ U , K} , & else .\end{matrix} \qquad [ Equation 2 ]$$

When the receiving end (e.g., server) observes an aggregated modulation symbol, an effective modulation order is 2^{μU}. However, the modulation order at each transmitting end (e.g., device) is U(2^{μ}−1)+1. For example, when q=6, μ=2, and U=3, 2^{μU} symbols corresponding to 000000 to 111111 are observed at the receiving end, and thus the modulation order is 2^{μu}. However, since only modulation symbols corresponding to 000000, 100000, 010000, 110000, 001000, 000100, 001100, 000010, 000001, and 000011 may be generated/transmitted from the transmitting ends, the modulation order is U(2^{μ}−1)+1. The important point here is that there should be no ambiguity between modulation symbols, when observed at the receiving end. A modulation method taking into this account is given as follows.

$${s}_{u} [ k ] = {P}_{sys} {ℳ}_{Q}^{sys} ( {c}_{u}^{sys , b} [ μ U ( k - 1 ) + 1 : μ Uk ] ) = \{ \begin{matrix}{P}_{sys} ( {c}_{u}^{sys , b} [ μ U ( k - 1 ) + u ] {2}^{⌈ \frac{u}{2} ⌉ - 1} - b ) , & if {( u )}_{2} = 1 \\ {jP}_{sys} ( {c}_{u}^{sys , b} [ μ U ( k - 1 ) + u ] {2}^{⌈ \frac{u}{2} ⌉ - 1} - b ) , & else\end{matrix} , \qquad [ Equation 3 ]$$

Herein, P_{sys} means a power scale value, and b means an offset value. P_{sys} and b may be appropriately determined depending on a purpose (e.g., optimization of power consumption at the transmitting end or optimization of a received signal range at the receiving end). For example, b may be determined in the following manner such that a constellation is observed symmetrically in the I-channel and the Q-channel to optimize the reception signal range of the receiving end.

$$b = \frac{{\sum }_{u ∈ {ℕ}_{odd}^{μ U}} {2}^{⌈ \frac{u}{2} ⌉ - 1} + j {\sum }_{u ∈ {ℕ}_{even}^{μ U}} {2}^{⌈ \frac{u}{2} ⌉ - 1}}{2 U} \qquad [ Equation 4 ]$$

An aggregated modulation symbol

$$s [ k ] ( = {\sum }_{u = 1}^{U} {s}_{u} [ k ] )$$

for k=1, . . . , K at the receiving end is as follows.

$$s [ k ] = {P}_{sys} ( {\sum }_{u ∈ {ℕ}_{odd}^{μ U}} {c}_{u}^{sys , b} [ μ U ( k - 1 ) + u ] {2}^{⌈ \frac{u}{2} ⌉ - 1} + j ( {\sum }_{u ∈ {ℕ}_{even}^{μ U}} {c}_{u}^{sys , b} [ μ U ( k - 1 ) + u ] {2}^{⌈ \frac{u}{2} ⌉ - 1} ) - Ub ) \qquad [ Equation 5 ]$$

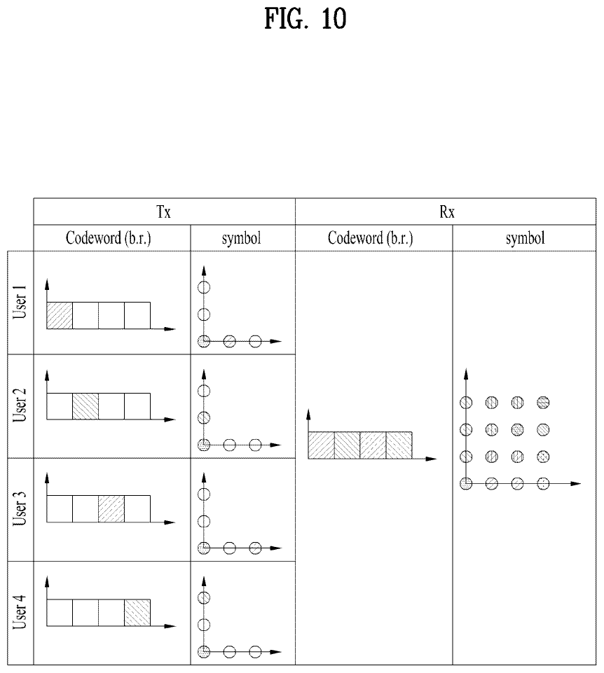

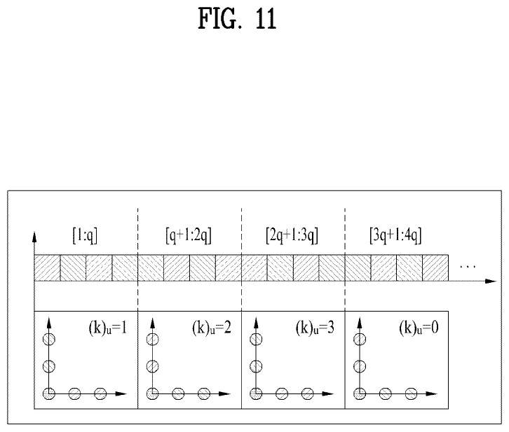

FIG. 10 illustrates an exemplary modulation process and reception process of a system part at a codeword binary representation level and a symbol level. When q=4, μ=1, and U=4, the modulation order at the transmitting ends is 5 (=U(2^{μ}−1)+1=4(2²−1)+1), and the modulation order of a symbol observed at the receiving end is 16(=2^{μU=1*4}). When the number of users (i.e. devices) is 3 (i.e., q=4, μ=1, and U=3), the modulation order at the transmitting ends is 4(=U(2^{μ}−1)+1=3(2²−1)+1), and the modulation order of a symbol observed at the receiving end is 8(=2^{μU=1+3}). Further, referring to FIG. 11, information bits may be circulated in length-q subsequences [1:q], [q+1:2q], [2q+1:3q], and [3q+1:4q] corresponding to modulation symbols, in each symbol index per user.

### [Parity Part]

Let the parity part of a codeword be

$${c}_{u}^{par , b} = {[ {c}_{u}^{b} [ k ] ]}_{k = qK + 1}^{qN} .$$

When a binary information sequence subject to information restriction is encoded, the system part of a codeword is also subject to information restriction, like the binary information sequence. However, since information restriction is not applied to the parity part of the codeword as a result of the encoding, the same Q-ary symbols may be received with as many overlaps as the number of users at the receiving end (this means that as many overlaps as the number of users may occur for each polynomial component). A method of distinguishing parity information of each user at the receiving end without ambiguity will be described below.

From each user's perspective, codeword symbol elements may be expressed as a length-q binary sequence. When it is assumed that the modulation order is p and a divider satisfies (q)ₚ=0, each codeword symbol may be divided by q/p, modulated with a modulation order of 2^{p}, and transmitted using q/p times more radio resources. For example, when q=6 and p=3, 8QAM may be used twice instead of 64QAM, for transmission.

Increasing the modulation order allows for efficient use of resources at the expense of increasing average power consumption per symbol. On the contrary, when the modulation order is reduced, the average power per symbol may be efficiently managed at the expense of increasing resource overhead. Resource efficiency increases linearly in proportion to the number of users, while average power increases exponentially in proportion to the number of users. The reason will be described, when modulation is described in more detail.

A modulation symbol sequence sᵤ[K+k] for k=1, . . . , q(N−K)/p of the parity part may be defined as

$${s}_{u} [ K + k ] = {P}_{par} {ℳ}_{Q}^{par} ( {c}_{u}^{par , b} [ p ( k - 1 ) + 1 : pk ] ) = {P}_{par} ( {\sum }_{l ∈ {ℕ}_{odd}^{p}} {A}_{⌈ \frac{l}{2} ⌉} {c}_{u}^{par , b} [ p ( k - 1 ) + l ] + j ( {\sum }_{l ∈ {ℕ}_{even}^{p}} {A}_{⌈ l / 2 ⌉} {c}_{u}^{par , b} [ p ( k - 1 ) + l ] ) - b ) \qquad [ Equation 6 ]$$

Pₚₐᵣ is a power scale value, and Aₗ and b are a strength value and an offset value. The offset value b is the same as described before regarding the system part, and for example, for the purpose of optimizing a received signal range, may be defined as follows.

$$b = \frac{{\sum }_{l ∈ {ℕ}_{odd}^{p}} {A}_{⌈ l / 2 ⌉} + j ( {\sum }_{l ∈ {ℕ}_{even}^{p}} {A}_{⌈ l / 2 ⌉} )}{2} \qquad [ Equation 7 ]$$

The purpose of the strength value is to eliminate ambiguity between parity symbols received from the users. To eliminate ambiguity, firstly, from the perspective of individual constellations, polynomial elements mapped to the same I (or Q) channel should be distinguished, and secondly, from the perspective of an aggregated constellation, even if as many symbols as the number of users are accumulated, polynomial elements corresponding to the symbols should be distinguished. In consideration of this, the strength value may be defined as follows.

$${A}_{i} = {\sum }_{l = 1}^{i - 1} {UA}_{l} + {Δ}_{i} \qquad [ Equation 8 ]$$

It may be set that Δᵢ=1 in a typical case. When each polynomial element is accumulated as many times as the number of users in the afore-described worst case, this is a device to distinguish the accumulation. For example, it is assumed that a constant term and a degree-2 term among polynomial elements are modulated and transmitted together on the I-channel. When the constant term is modulated with strength 1, the degree-2 term should be modulated with at least a strength of U+ε (ε>0) to eliminate ambiguity.

An aggregated modulation symbol at the receiving end is given by

$$s [ K + k ] = {P}_{par} ( {\sum }_{u = 1}^{U} ( {\sum }_{l ∈ {ℕ}_{o d d}^{p}} {c}_{u}^{p a r , b} [ p ( k - 1 ) + l ] {A}_{⌈ \frac{l}{2} ⌉} + j ( {\sum }_{l ∈ {ℕ}_{e v e n}^{p}} {c}_{u}^{p a r , b} [ p ( k - 1 ) + l ] {A}_{⌈ \frac{l}{2} ⌉} ) ) - U b ) \qquad [ Equation 9 ]$$

Since different modulation schemes and modulation orders are used for the system part and the parity part, a system part power scaling value and a parity part power scaling value may be optionally set depending on a system environment and a target performance. Let the constellation sets of the system part and the parity part be denoted by

$${ℂ}_{q , μ U}^{s y s} and {ℂ}_{p , U}^{par} .$$

Let the average powers of symbols on the constellation sets be

$${s}_{a v}^{s y s} and {s}_{a v}^{par} .$$

Since the probabilities of the parity part being modulated to respective symbols on a constellation are uniformly distributed,

$${s}_{a v}^{par}$$

is the average of the power of total symbols. On the other hand, since a symbol corresponding to an all-zero sequence in the system part is common information for all users, the probability of the symbol being selected is higher than other symbols by as much as the number of users,

$${s}_{a v}^{s y s}$$

may be determined in consideration of the all-zero sequence. For example, when=4, μ=1, and U=4, an information combination that each user may transmit is (0000 or 1000)/(0000 or 0100)/(0000 or 0010)/(0000 or 0001) due to information restriction. Therefore, the probability of a symbol corresponding to 0000 being selected is U times greater than that of a symbol corresponding to another binary sequence. When the average powers of the system part and the parity part are equal, it may be set that

$${P}_{s y s} = 1 / \sqrt{{s}_{a v}^{s y s}} and {P}_{par} = 1 / \sqrt{{s}_{a v}^{par}} .$$

When the average power per symbol is equal in both parts, it may be set that

$${P}_{s y s} = {P}_{par} = \sqrt{N / ( {Ks}_{a v}^{s y s} + ( N - K ) {s}_{a v}^{par} )} .$$

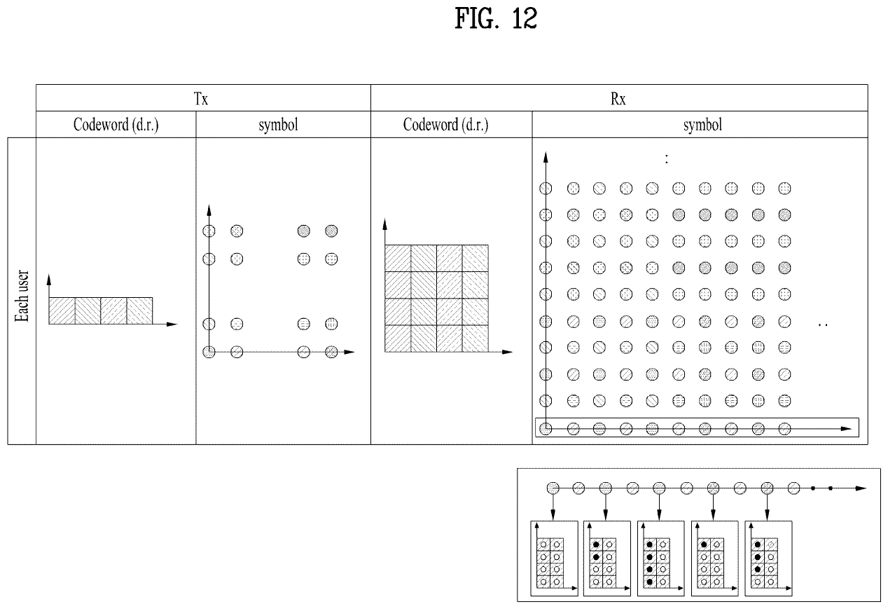

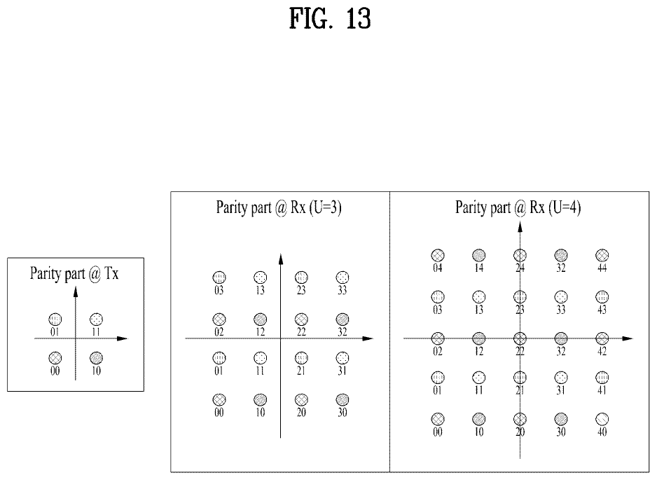

FIG. 12 illustrates an exemplary modulation process and reception process of a parity part at a codeword binary representation level and a symbol level. FIG. 12 illustrates a case where the parity part is modulated and transmitted without partitioning in a situation where Q=16 (i.e., q=4) and U=4. FIG. 13 illustrates a case in which a parity part is divided into two, modulated, and transmitted (p=q/2) in a situation with Q=16 (i.e., q=4) and U=3 or 4. In the drawings, the same patterns mean the same symbols.

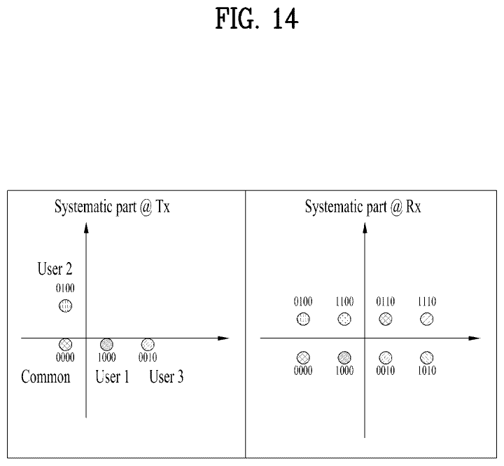

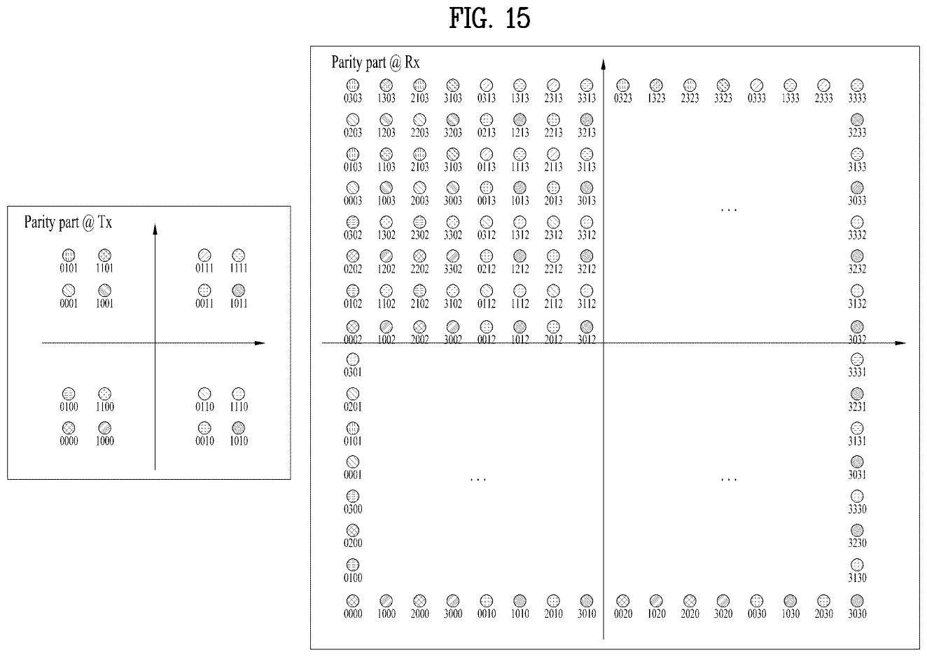

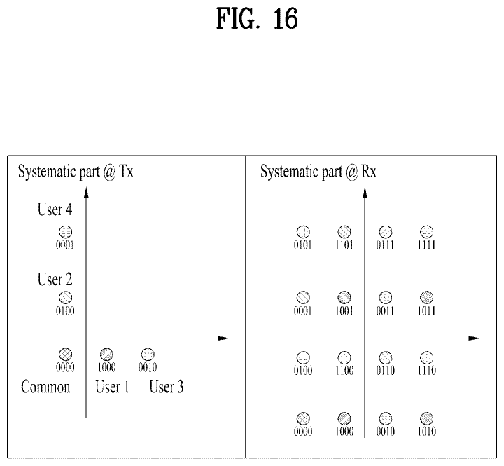

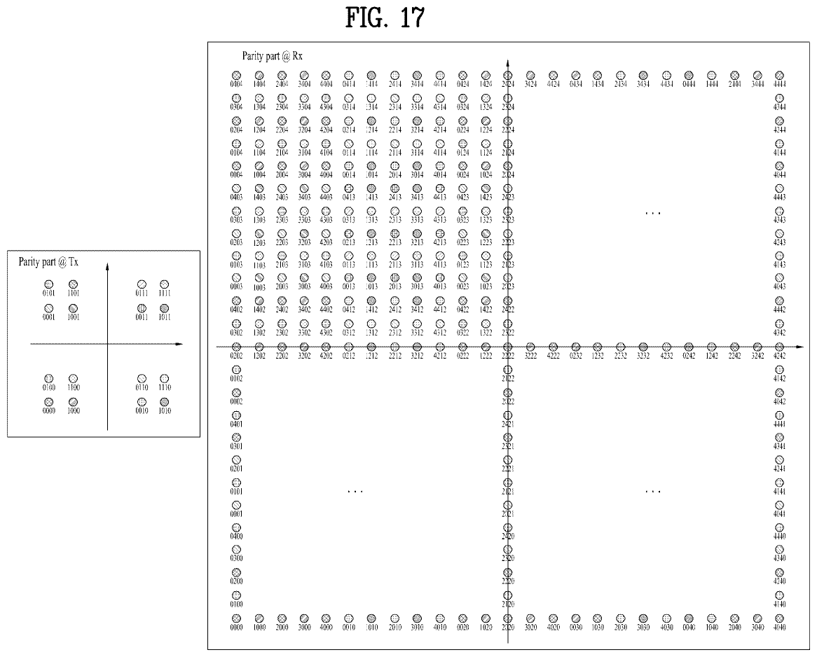

FIGS. 14 to 17 are exemplary diagrams illustrating (individual) constellations at transmitters and (aggregated) constellations at a receiver in specific cases. FIGS. 14 and 15 are exemplary diagrams illustrating individual constellations and aggregated constellations of a system part and a parity part in a situation where Q=16 (i.e., q=4) and U=4. FIGS. 16 and 17 are exemplary diagrams illustrating individual constellations and aggregated constellations of a system part and a parity part in a situation where Q=16 (i.e., q=4) and U=3. In the drawings, the same patterns mean the same symbols.

### Demodulation

Both typical maximum-likelihood (ML) decoding and belief propagation (BP) decoding are applicable. However, a demodulation part from which a soft value is obtained prior to decoding is different from before. A demodulation method performed before decoding will be described. When U users perform transmission by AirComp, an observed constellation hypothesis size increases significantly. However, the actual number of symbols remains the same regardless of the number of users. Since there is no modulo operation on the air channel, as the number of users increases, the number of constellations representing the same symbol increases, as seen from the afore-described drawings.

In the system part, a soft value corresponding to each symbol may be obtained through demodulation for every observed constellation point. In the parity part, considering that different constellations represent the same symbol, a soft value for each symbol may be obtained by reducing a search space on a constellation.

For understanding, a process of reducing constellation hypotheses for demodulation of the parity part is described in more detail. Let a received signal be r=Ps+n where P represents an average transmission power through power control and pre-equalization. n˜ [symbol] (0,1) or N (0,1) means (complex) Gaussian noise. Let a set of observable constellations according to given Q and U be denoted by [symbol] . As illustrated in the afore-described drawings, a constellation set may be as a disjoint constellation set for each symbol. Let a constellation set for symbol s be denoted by

$${ℂ}_{s}^{Q , U} .$$

Given a received signal r, an effective constellation set may be constructed for each element r[n] as follows.

$${\overline{ℂ}}_{n}^{Q , U} = {\{ arg {min}_{x ∈ {ℂ}_{s}^{Q , U}} ( {‖ x - r [ n ] ‖}^{2} ) \}}_{s = 1}^{Q} \qquad [ Equation 10 ]$$

Decoding may be performed by obtaining soft values of Q-ary symbols using

$${\overline{ℂ}}_{n}^{Q , U}$$

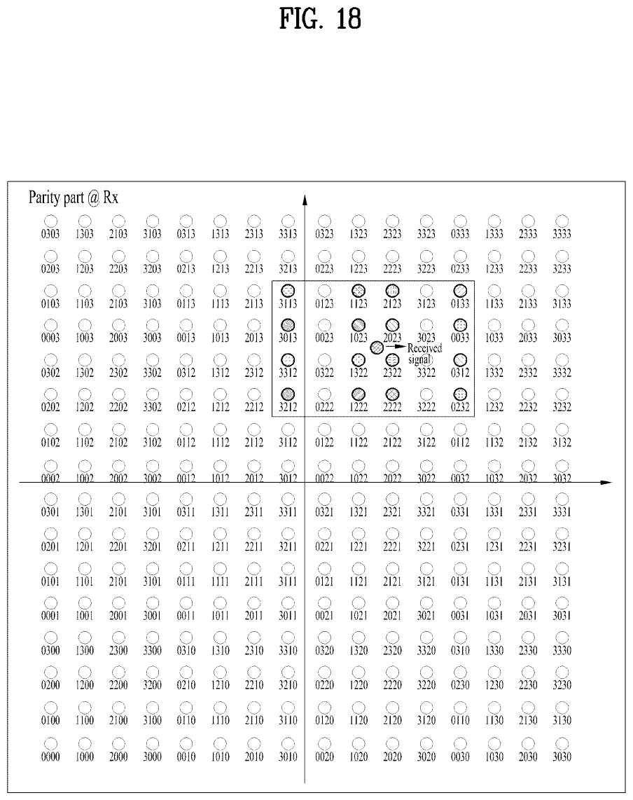

constructed in this way. Further, it is also possible to perform this calculation process offline in advance to construct multiple effective constellation sets and retrieve a corresponding effective constellation set according to the value of a received signal. In this case, memory is inefficiently used in spite of the advantage of obtaining an effective constellation for each symbol without calculation. FIG. 18 is a simplified diagram illustrating a process of demodulating a parity part. For a given r[n], an observable constellation set [symbol] (16×16) and an effective constellation set

$${\overline{ℂ}}_{n}^{Q , U}$$

(4×4) are shown.

### Desired Sequence Acquisition

Typical decoding is performed using soft values obtained through the demodulation process. Let an aggregated sequence obtained through decoding be denoted by ĉ. Herein, let the transmitted system part be denoted by ĉ_{sys}=ĉ[1:K]. Let a sequence in which each symbol is converted to its mapped binary representation according to a finite field [symbol] be denoted, by

$${\hat{c}}_{s y s}^{b} .$$

When μU<q, q−μU bits at the trailing end of a length-q binary sequence version of symbol ĉ[k] are fixed to zeros, and thus are omitted. A desired sequence may be transformed from

$${\hat{c}}_{s y s}^{b}$$

as illustrated in the following equation.

$${c}_{d e s} = {[ {[ ( {\sum }_{l = 1}^{U} {\hat{c}}_{s y s}^{b} [ μ U ( k - 1 ) + μ ( l - 1 ) + i ] ) / U ]}_{i = 1}^{μ} ]}_{k = 1}^{K} \qquad [ Equation 11 ]$$

It is assumed that an information sequence with total length μK is a total bit sequence representing a model, and that each weight is represented in L bits. Herein, an aggregated weight value may be obtained by the following equation.

$$w = {[ w [ t ] ]}_{t = 1}^{μ K / L} where w [ t ] = {\sum }_{k = 1}^{L} {2}^{L - k} {c}_{d e s} [ L ( t - 1 ) + k ] \qquad [ Equation 12 ]$$

### Performance Evaluation

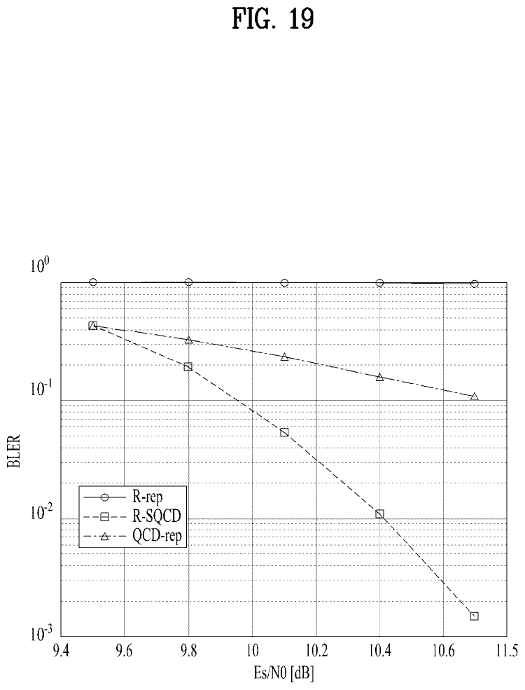

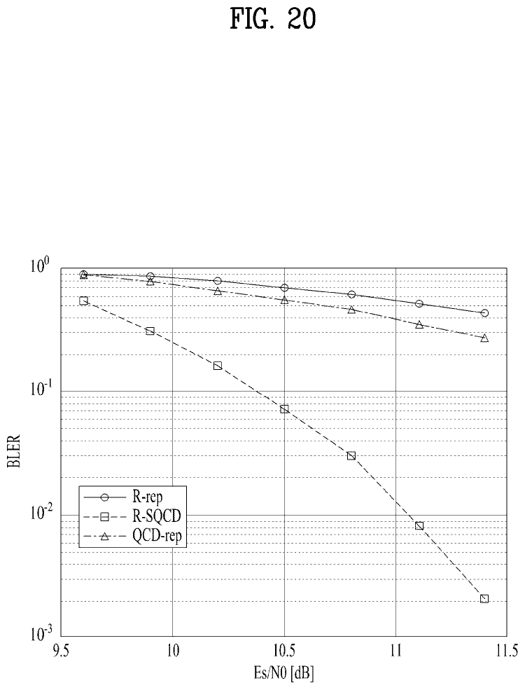

FIGS. 19 and 20 are diagrams that compare an information-restriction repeating method (R-rep), a method of repeating a Q-ary code without information restriction (QCD-rep), and the proposed information restriction-based scalable Q-ary code method (R-SQCD). The use of an LDPC code with K=288, N=576 and Q=64 is assumed, and a parity part is divided and transmitted in 8QAM. FIG. 19 is for a situation where each of three users transmits information in two bits of a binary subsequence of length 6, and FIG. 20 is for a situation where each of six users transmits information in one bit of a binary subsequence of length of 6. For a fair comparison, the transmission rates are set to be equal and the resources used are set to be similar. In terms of transmission rates, the QCD method has a transmission rate that is three or six times that of the other two methods. In terms of resource use, when it is assumed that the radio resources used for R-SQCD transmission are three REs, R-rep uses the same three REs on the assumption of three repetitions, and QCD uses four REs. In this regard, it is assumed that R-SQCD and R-rep transmit 3 (6) symbol sequences using 9 REs (18 REs) to match the transmission rate, QCD repeats 2 (4) times using 8 REs (16 REs), and more power is allocated by as much as a decreased portion of resources.

Further, in FIG. 19, the average power of the constellation of the system part and the average power of the constellation of the parity part in R-SQCD are almost the same, and thus power scaling is performed such that the overall average power is 1. In FIG. 20, since the difference between the two average powers is large, power scaling is performed such that each average power is 1. The difference between the two average powers is large when the constellation of the parity part is much larger than that of the system part. When the overall average power is adjusted, excessive loss occurs in the power of the system part, resulting in loss in a waterfall area. It may be seen that the R-SQCD method has excellent performance in both cases. The performance difference between R-SQCD and R-rep is from coding gains, and the performance difference between R-SQCD and QCD-rep methods is from quotient estimation errors.

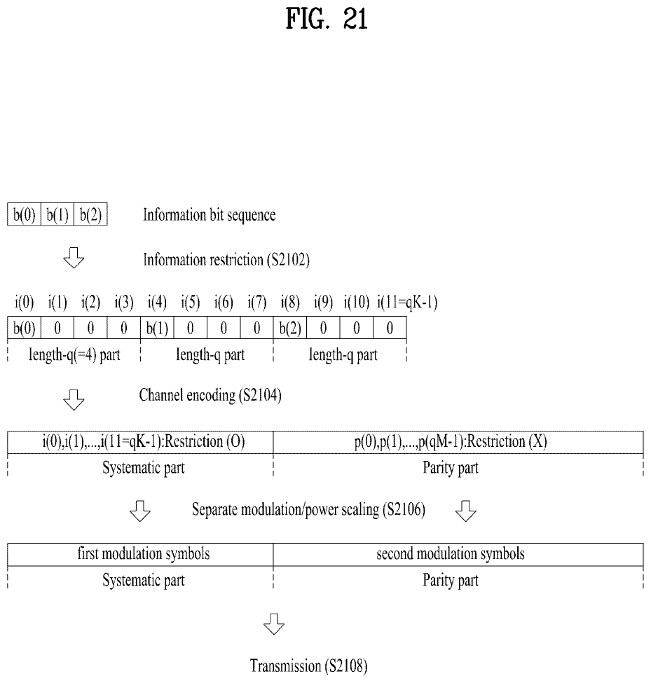

FIG. 21 illustrates an exemplary transmission process according to an embodiment of the disclosure. Referring to FIG. 21, a UE may generate a second data bit sequence by adding q−u zero bits to every u bits in a first data bit sequence (S2102). That is, information restriction may be applied to the first data bit sequence. The UE may then generate a codeword including a system part and a parity part by encoding the second data bit sequence (S2104). Since the system part is the same as the second data bit sequence, it retains the information restriction of the second data bit sequence. However, the information restriction is not maintained in the parity part, because information of each bit of the second data bit sequence is mixed during channel coding. Subsequently, the UE may provide a modulation symbol sequence corresponding to the codeword by applying a different modulation and power scaling combination to every q-bit unit of the system part and the parity part of the codeword (S2106). This is done because different combinations of modulation and power scaling are required to distinguish received aggregated data at a receiving end, due to application and non-application of the information restriction. For example, FIGS. 10 to 17 may be referred to. The UE may then transmit the modulation symbol sequence (S2108). Herein, q may be a power of 2, and u may be an integer of 1 or larger. In addition, the second data bit sequence includes u data bits and q−u zero bits in each of q-bit units, and the positions of the u data bits in each of the q-bit units are determined based on an order of the q-bit units and/or UE identification information. Further, the first data bit sequence may include information about a training result according to federated learning, u may be q/U, and U may represent the number of UEs participating in the federated learning.

The various descriptions, functions, procedures, proposals, methods, and/or operational flowcharts proposals of the disclosure described above in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

In the disclosure, the at least one memory (e.g., 104 or 204) may store instructions or programs, and the instructions or programs may cause, when executed, at least one processor operably connected to the at least one memory to perform operations according to some embodiments or implementations of the disclosure.

In the disclosure, a computer readable storage medium may store at least one instruction or program, and the at least one instruction or program may cause, when executed by at least one processor, the at least one processor to perform operations according to some embodiments or implementations of the disclosure.

In the disclosure, a computer program may be recorded in at least one computer-readable (non-volatile) storage medium, and may include a program code that causes (at least one processor) to perform an operation when being executed according to some embodiments or implements of the disclosure. The computer program may be provided in the form of a computer program product. The computer program product may include at least one computer readable (non-volatile) storage medium, and the computer readable storage medium may include a program code that causes (at least one processor) to perform an operation when being executed according to some embodiments or implements of the disclosure.

In the disclosure, a processing device or apparatus may include at least one processor, and at least one computer memory operably connected to the at least one processor. The at least one computer memory may store instructions or programs, and the instructions or programs may cause, when executed, the at least one processor operably connected to the at least one memory to perform operations according to some embodiments or implementations of the disclosure.

A communication device of the disclosure includes at least one processor; and at least one computer memory operably connected to the at least one processor and configured to store instructions for causing, when executed, the at least one processor to perform operations according to example(s) of the disclosure described later.

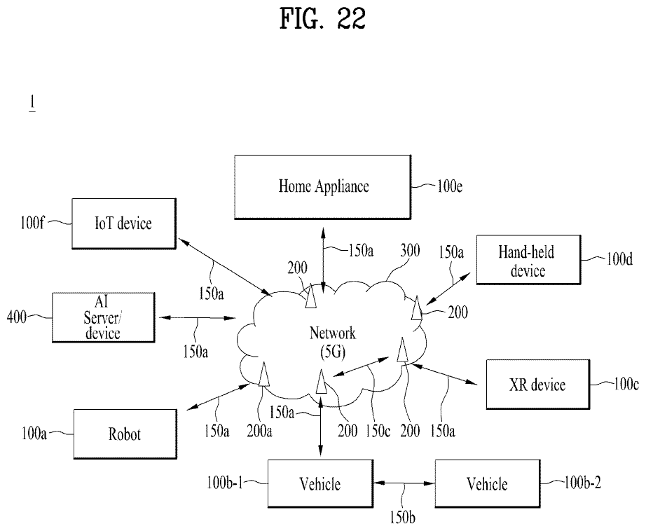

FIG. 22 illustrates a communication system 1 applied to the disclosure.

Referring to FIG. 22, a communication system 1 applied to the disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the disclosure.

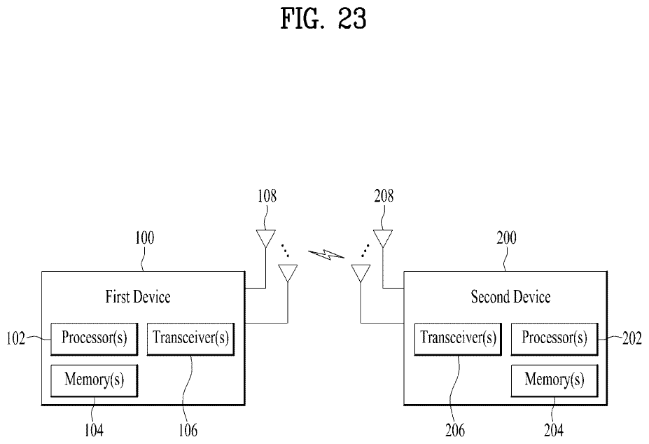

FIG. 23 illustrates wireless devices applicable to the disclosure.

Referring to FIG. 23, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 22.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

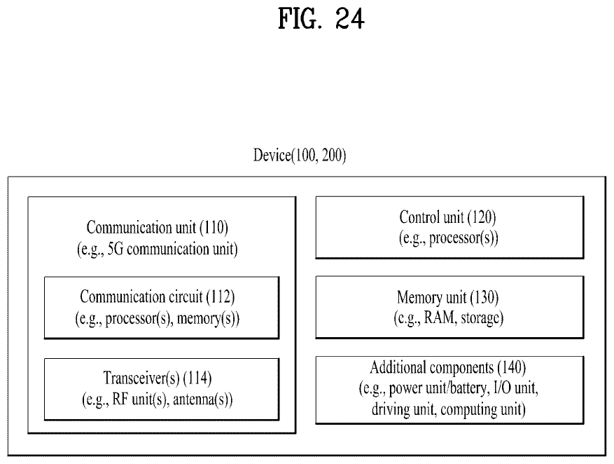

FIG. 24 illustrates another example of a wireless device applied to the disclosure. The wireless device may be implemented in various forms according to a use-case/service (refer to FIG. 22).

Referring to FIG. 24, wireless devices 100 and 200 may correspond to the wireless devices 100 and 200 of FIG. 23 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 23. For example, the transceiver(s) 114 may include the one or more transceivers 106 and 206 and/or the one or more antennas 108 and 208 of FIG. 23. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 22), the vehicles (100b-1 and 100b-2 of FIG. 22), the XR device (100c of FIG. 22), the hand-held device (100d of FIG. 22), the home appliance (100e of FIG. 22), the IoT device (100f of FIG. 22), a digital broadcast terminal, a hologram device, a public safety device, an MTC device, a medicine device, a fintech device (or a finance device), a security device, a climate/environment device, the AI server/device (400 of FIG. 22), the BSs (200 of FIG. 22), a network node, etc. The wireless device may be used in a mobile or fixed place according to a use-example/service.

In FIG. 24, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

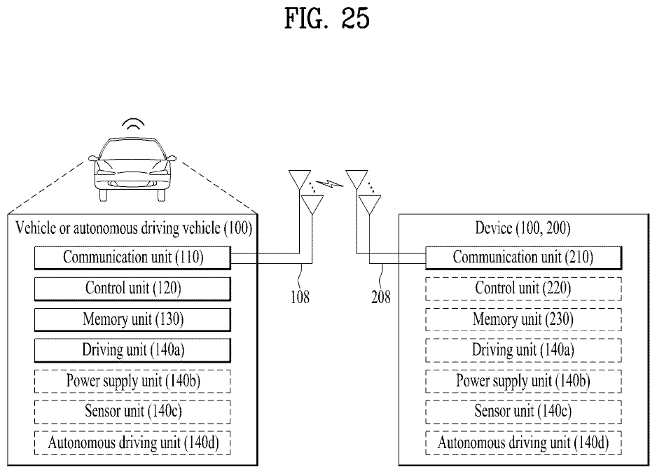

FIG. 25 illustrates a vehicle or an autonomous driving vehicle applied to the disclosure. The vehicle or autonomous driving vehicle may be implemented by a mobile robot, a car, a train, a manned/unmanned Aerial Vehicle (AV), a ship, etc.

Referring to FIG. 25, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 24, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

The above-described embodiments correspond to combinations of elements and features of the disclosure in prescribed forms. And, the respective elements or features may be considered as selective unless they are explicitly mentioned. Each of the elements or features may be implemented in a form failing to be combined with other elements or features. Moreover, it is able to implement an embodiment of the disclosure by combining elements and/or features together in part. A sequence of operations explained for each embodiment of the disclosure may be modified. Some configurations or features of one embodiment may be included in another embodiment or may be substituted for corresponding configurations or features of another embodiment. And, it is apparently understandable that an embodiment is configured by combining claims failing to have relation of explicit citation in the appended claims together or may be included as new claims by amendment after filing an application.

Those skilled in the art will appreciate that the disclosure may be carried out in other specific ways than those set forth herein without departing from the spirit and essential characteristics of the disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The disclosure is applicable to UEs. BSs or other apparatuses of a wireless mobile communication system.

1. A method of transmitting a signal by a user equipment (UE) in a wireless communication system, the method comprising:
generating a second data bit sequence by adding q−u zero bits to every u bits in a first data bit sequence;
generating a codeword including a system part and a parity part by encoding the second data bit sequence;
providing a modulation symbol sequence corresponding to the codeword by applying a different modulation and power scaling combination to every q-bit unit of the system part and the parity part in the codeword; and
transmitting the modulation symbol sequence,
wherein q is a power of 2, and u is an integer equal to or greater than 1.

2. The method of claim 1, wherein the second data bit sequence includes u data bits and q−u zero bits in each of q-bit units, and positions of the u data bits in each of the q-bit units are changed based on an order of the q-bit units.

3. The method of claim 1, wherein the second data bit sequence includes u data bits and q−u zero bits in each of q-bit units, and positions of the u data bits in each of the q-bit units are changed based on UE identification information.

4. The method of claim 1, wherein the first data bit sequence includes information about a training result according to federated learning, u is q/U, and U represents a number of UEs participating in the federated learning.

5. A user equipment (UE) used in a wireless communication system, comprising:
at least one radio frequency (RF) unit;
at least one processor; and
at least one computer memory operably connected to the at least one processor, and when executed, causing the at least one processor to perform operations,
wherein the operations include:
generating a codeword including a system part and a parity part by encoding the second data bit sequence;
providing a modulation symbol sequence corresponding to the codeword by applying a different modulation and power scaling combination to every q-bit unit of the system part and the parity part in the codeword; and
transmitting the modulation symbol sequence, and
wherein q is a power of 2, and u is an integer equal to or greater than 1.

6. The UE of claim 5, wherein the second data bit sequence includes u data bits and q−u zero bits in each of q-bit units, and positions of the u data bits in each of the q-bit units are changed based on an order of the q-bit units.

7. The UE of claim 5, wherein the second data bit sequence includes u data bits and q−u zero bits in each of q-bit units, and positions of the u data bits in each of the q-bit units are changed based on UE identification information.

8. The UE of claim 5, wherein the first data bit sequence includes information about a training result according to federated learning, u is q/U, and U represents a number of UEs participating in the federated learning.

9. An apparatus for a user equipment (UE), comprising:
at least one processor; and
at least one computer memory operably connected to the at least one processor, and when executed, causing the at least one processor to perform operations,
wherein the operations include:
generating a codeword including a system part and a parity part by encoding the second data bit sequence;
providing a modulation symbol sequence corresponding to the codeword by applying a different modulation and power scaling combination to every q-bit unit of the system part and the parity part in the codeword; and
transmitting the modulation symbol sequence, and
wherein q is a power of 2, and u is an integer equal to or greater than 1.

10. The apparatus of claim 9, wherein the second data bit sequence includes u data bits and q−u zero bits in each of q-bit units, and positions of the u data bits in each of the q-bit units are changed based on an order of the q-bit units.

11. The apparatus of claim 9, wherein the second data bit sequence includes u data bits and q−u zero bits in each of q-bit units, and positions of the u data bits in each of the q-bit units are changed based on UE identification information.

12. The apparatus of claim 9, wherein the first data bit sequence includes information about a training result according to federated learning, u is q/U, and U represents a number of UEs participating in the federated learning.

13. A computer-readable storage medium including at least one computer program which when executed, causes at least one processor to perform operations,
wherein the operations include:
generating a codeword including a system part and a parity part by encoding the second data bit sequence;
providing a modulation symbol sequence corresponding to the codeword by applying a different modulation and power scaling combination to every q-bit unit of the system part and the parity part in the codeword; and
transmitting the modulation symbol sequence, and
wherein q is a power of 2, and u is an integer equal to or greater than 1.

14. The computer-readable storage medium of claim 13, wherein the second data bit sequence includes u data bits and q−u zero bits in each of q-bit units, and positions of the u data bits in each of the q-bit units are changed based on an order of the q-bit units.

15. The computer-readable storage medium of claim 13, wherein the second data bit sequence includes u data bits and q−u zero bits in each of q-bit units, and positions of the u data bits in each of the q-bit units are changed based on UE identification information.

16. The computer-readable storage medium of claim 13, wherein the first data bit sequence includes information about a training result according to federated learning, u is q/U, and U represents a number of UEs participating in the federated learning.
